(19) United States
(12) Patent Application Publication
(10) Pub. No.: US 2021/0195547 A1
(43) Pub. Date: Jun. 24, 2021

(54) UPDATING CELL AND TIMING ADVANCE (TA) AND/OR TIMING ADVANCE GROUP IDENTIFICATION (TAG-ID) PER CELL IN L1/L2-BASED INTER-CELL MOBILITY

(71) Applicant: QUALCOMM Incorporated, San Diego, CA (US)

(72) Inventors: Hamed PEZESHKI, San Diego, CA (US); Yan ZHOU, San Diego, CA (US); Tao LUO, San Diego, CA (US)

(21) Appl. No.: 17/131,670

(22) Filed: Dec. 22, 2020

Related U.S. Application Data
(60) Provisional application No. 62/962,136, filed on Jan. 16, 2020.
(60) Provisional application No. 62/953,146, filed on Dec. 23, 2019.

(51) Int. Cl. H04W 56/00; H04W 74/08; H04W 72/12; H04W 74/00; H04W 28/06

(52) U.S. Cl. CPC H04W 56/0045; H04W 56/0005; H04W 28/06; H04W 72/1289; H04W 74/006; H04W 74/0833

(57) ABSTRACT

Aspects of the present disclosure provide apparatus, methods, processing systems, and computer readable mediums for updating timing advance information in L1 (physical layer) and L2 (medium access control (MAC) layer) based inter-cell mobility. An example method generally includes receiving, via physical (PHY) layer or medium access control (MAC) layer signaling, a joint update to at least one serving cell to serve the UE and a timing advance (TA); and applying the updated TA while communicating in the at least one serving cell.

### CROSS-REFERENCE TO RELATED APPLICATIONS

This application claims benefit to U.S. Provisional Patent Application Ser. No. 62/953,146, entitled “Updating Cell and Timing Advance (TA) and/or Timing Advance Group Identification (TAG-ID) Per Cell In L1/L2-Based Inter-Cell Mobility” and filed Dec. 23, 2019, and U.S. Provisional Patent Application Ser. No. 62/962,136, entitled “Updating Cell and Timing Advance (TA) and/or Timing Advance Group Identification (TAG-ID) Per Cell In L1/L2-Based Inter-Cell Mobility” and filed Jan. 16, 2020, both of which are assigned to the assignee hereof, the contents of which are hereby incorporated by reference in their entirety.

### TECHNICAL FIELD

Aspects of the present disclosure relate to wireless communications, and more particularly, to techniques for jointly updating, through physical layer (PHY) or medium access control (MAC) layer signaling, cell and timing advance (TA) information.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (for example, bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (for example, 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE.

### SUMMARY

The systems, methods, and devices of the disclosure each have several innovative aspects, no single one of which is solely responsible for the desirable attributes.

One innovative aspect of the subject matter described in this disclosure can be implemented in a method for wireless communication by a user equipment (UE). The method generally includes receiving, via physical layer or medium access control (MAC) layer signaling, a joint update to at least one serving cell to serve the UE and a timing advance (TA); and applying the updated TA while communicating in the at least one serving cell.

One innovative aspect of the subject matter described in this disclosure can be implemented in a method for wireless communication by a user equipment (UE). The method generally includes receiving, via physical layer or medium access control (MAC) layer signaling, an update to a timing advance (TA) group (TAG) ID for one or more serving cells of the UE; and applying the update while communicating in the one or more serving cells.

One innovative aspect of the subject matter described in this disclosure can be implemented in a method for wireless communication by a network entity. The method generally includes determining at least one timing advance (TA) for a user equipment (UE) in at least one serving cell; and sending the UE, via physical layer or medium access control (MAC) layer signaling, a joint update to the at least one serving cell to serve the UE and the TA.

One innovative aspect of the subject matter described in this disclosure can be implemented in a method for wireless communication by a network entity. The method generally includes determining an update to a timing advance (TA) group (TAG) ID for one or more serving cells of a user equipment (UE); and sending the update to the UE, via physical layer or medium access control (MAC) layer signaling.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail some illustrative features of the one or more aspects. These features are indicative, however, of but a few of the various ways in which the principles of various aspects may be employed.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows an example wireless communication network in which some aspects of the present disclosure may be performed.

FIG. 2 shows a block diagram illustrating an example base station (BS) and an example user equipment (UE) in accordance with some aspects of the present disclosure.

FIG. 3 illustrates an example of a frame format for a telecommunication system, in accordance with certain aspects of the present disclosure.

FIG. 4 illustrates example operations for wireless communication by a user equipment (UE), in accordance with some aspects of the present disclosure.

FIG. 5 illustrates example operations for wireless communication by a network entity, in accordance with some aspects of the present disclosure.

FIG. 6 is a call flow diagram illustrating messages exchanged between a user equipment (UE) and network entities for timing advance updates in L1/L2 inter-cell mobility, in accordance with some aspects of the present disclosure.

FIG. 7 illustrates example operations for wireless communication by a user equipment (UE), in accordance with some aspects of the present disclosure.

FIG. 8 illustrates example operations for wireless communication by a network entity, in accordance with some aspects of the present disclosure.

FIG. 9 illustrates a communications device that may include various components configured to perform operations for the techniques disclosed herein in accordance with aspects of the present disclosure.

FIG. 10 illustrates a communications device that may include various components configured to perform operations for the techniques disclosed herein in accordance with aspects of the present disclosure.

FIG. 11 illustrates a communications device that may include various components configured to perform operations for the techniques disclosed herein in accordance with aspects of the present disclosure.

FIG. 12 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for updating, through physical layer (PHY) or medium access control (MAC) layer signaling, cell and timing advance (TA) and/or timing advance group identification (TAG-ID) per cell.

The following description provides examples of jointly updating, through physical layer (PHY) or medium access control (MAC) layer signaling, cell and timing advance (TA) information, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

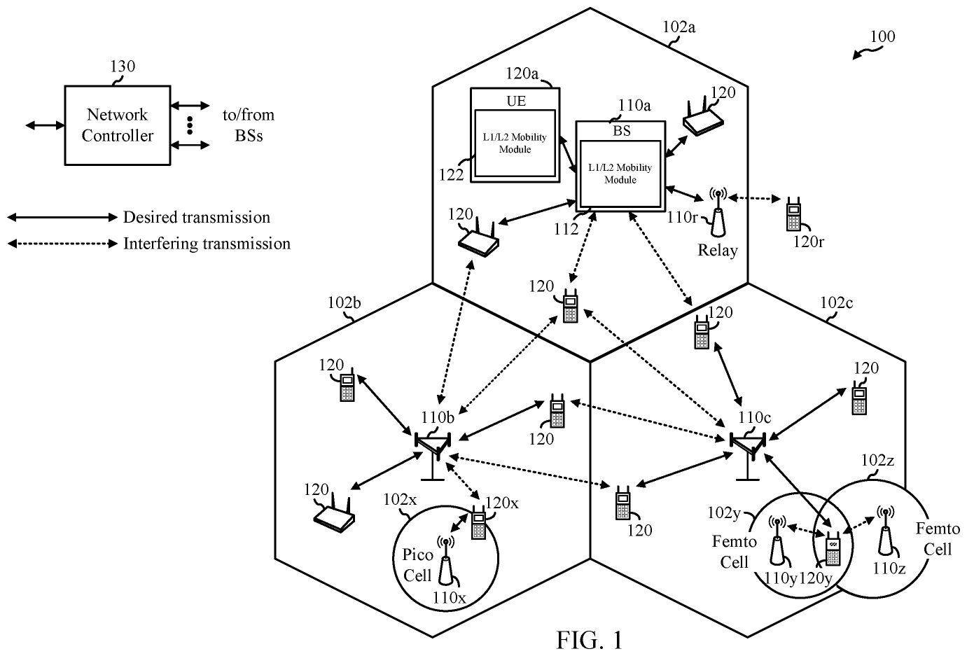

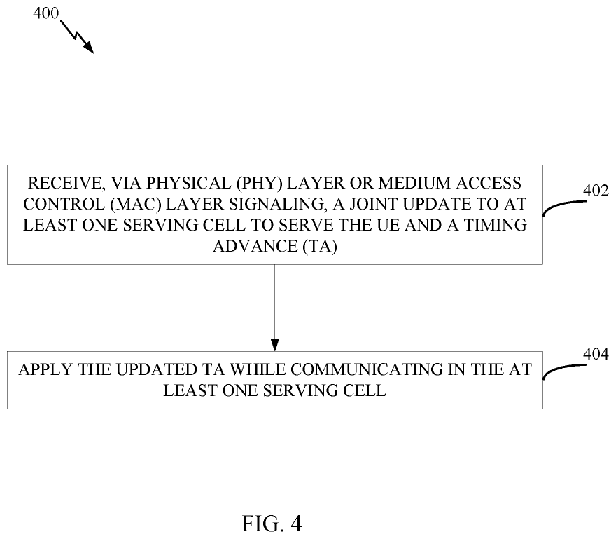

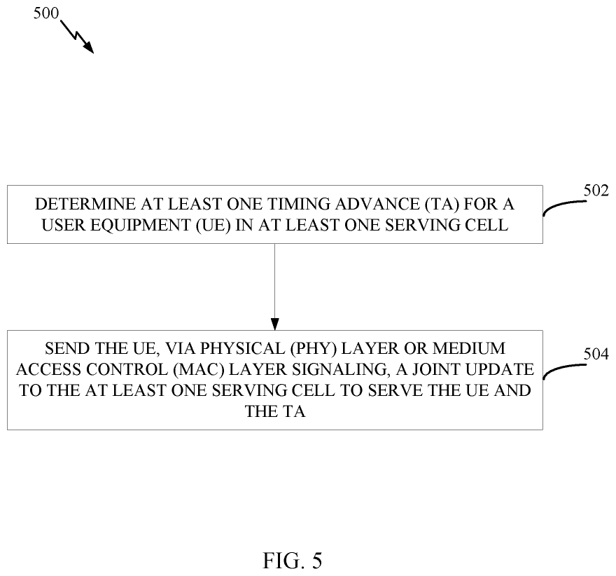

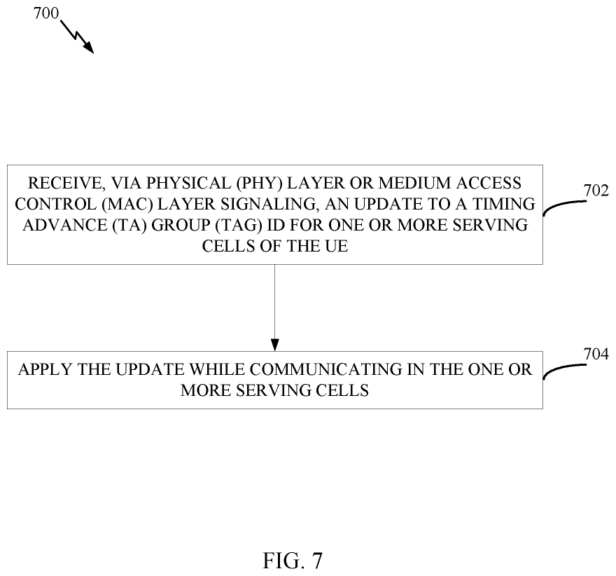

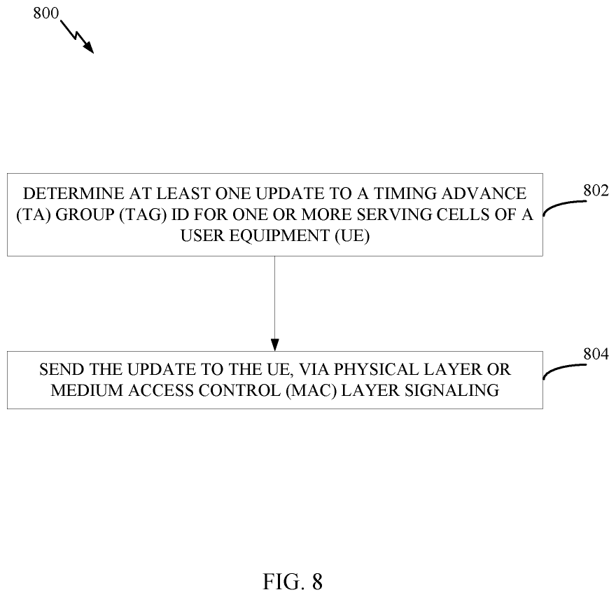

FIG. 1 illustrates an example wireless communication network 100 in which aspects of the present disclosure may be performed. For example, as shown in FIG. 1, UE 120a may include an L1/L2 mobility module 122 that may be configured to perform (or cause UE 120a to perform) operations 400 of FIG. 4 and/or operations 700 of FIG. 7. Similarly, a base station 110a may include an L1/L2 mobility module 112 that may be configured to perform (or cause the base station 110a to perform) operations 500 of FIG. 5 and/or operations 800 of FIG. 8.

NR access (for example, 5G NR) may support various wireless communication services, such as enhanced mobile broadband (eMBB) targeting wide bandwidth (for example, 80 MHz or beyond), millimeter wave (mmWave) targeting high carrier frequency (for example, 25 GHz or beyond), massive machine type communications MTC (mMTC) targeting non-backward compatible MTC techniques, or mission critical services targeting ultra-reliable low-latency communications (URLLC). These services may include latency and reliability requirements. These services may also have different transmission time intervals (TTI) to meet respective quality of service (QoS) requirements. In addition, these services may co-exist in the same time-domain resource (for example, a slot or subframe) or frequency-domain resource (for example, component carrier).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another or to one or more other BSs or network nodes (not shown) in wireless communication network 100 through various types of backhaul interfaces (for example, a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (for example, 120x, 120y, etc.) may be dispersed throughout the wireless communication network 100, and each UE 120 may be stationary or mobile.

Wireless communication network 100 may also include relay stations (for example, relay station 110r), also referred to as relays or the like, that receive a transmission of data or other information from an upstream station (for example, a BS 110a or a UE 120r) and sends a transmission of the data or other information to a downstream station (for example, a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (for example, directly or indirectly) via wireless or wireline backhaul.

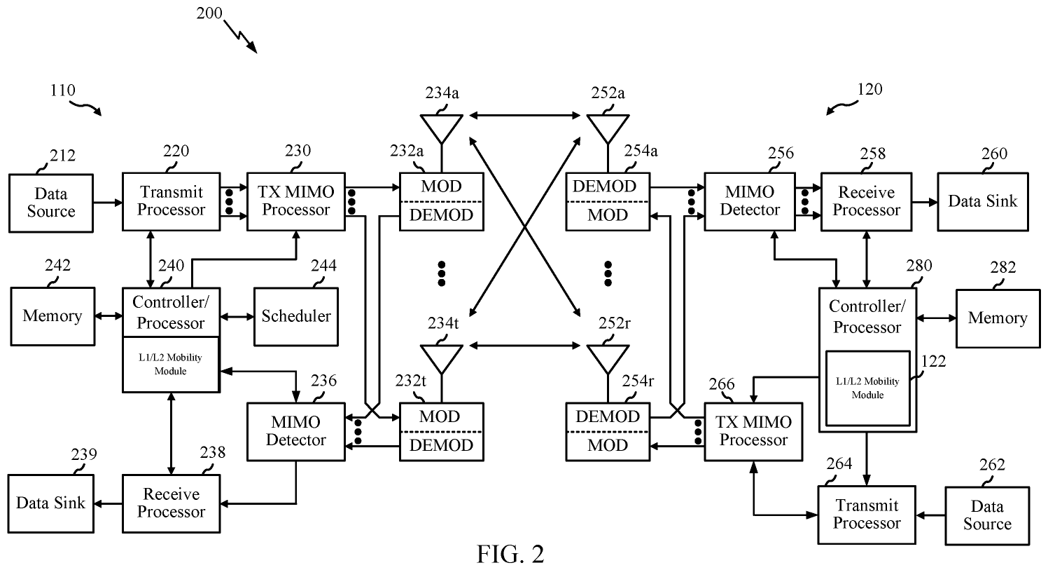

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

The controller/processor 280 or other processors and modules at the UE 120 may perform or direct the execution of processes for the techniques described herein. As shown in FIG. 2, the controller/processor 280 of the UE 120 has an L1/L2 Mobility Module 122 that may be configured to perform operations 400 of FIG. 4 and/or operations 700 of FIG. 7, as discussed in further detail below. The controller/processor 240 of the base station 110 includes an L1/L2 Mobility Module that may be configured to perform operations 500 of FIG. 5 and/or operations 800 of FIG. 8, as discussed in further detail below. Although shown at the Controller/Processor, other components of the UE or BS may be used to perform the operations described herein.

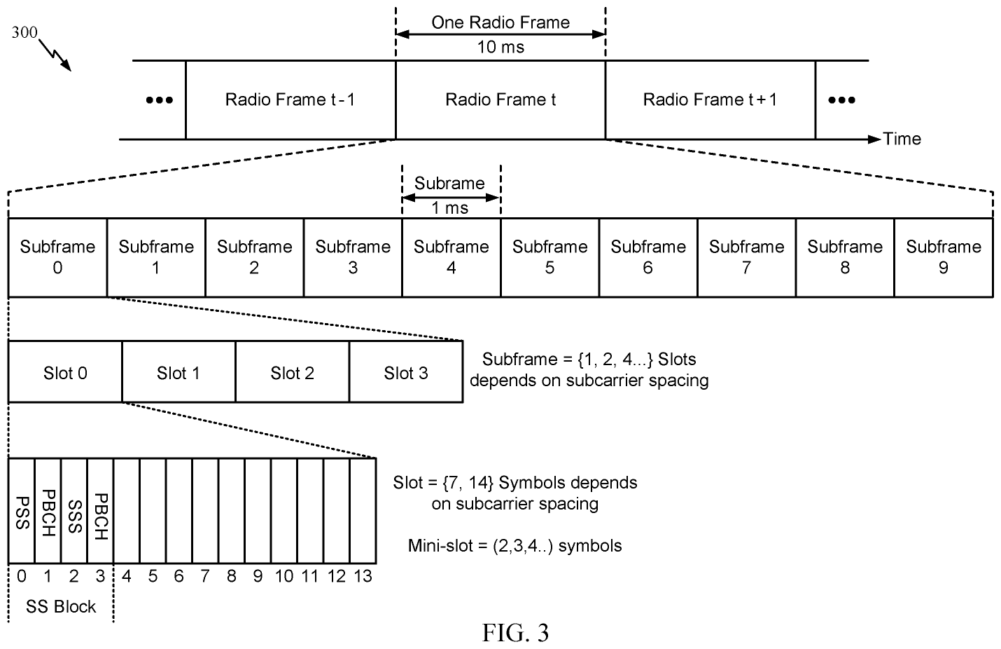

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE. According to aspects of the present disclosure, a CORESET is a set of time and frequency domain resources, defined in units of resource element groups (REGs). Each REG may comprise a fixed number (e.g., twelve) tones in one symbol period (e.g., a symbol period of a slot), where one tone in one symbol period is referred to as a resource element (RE). A fixed number of REGs may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE, and the UE may receive the NR-PDCCH by searching in search spaces for the UE and decoding the NR-PDCCH transmitted by the NodeB.

### Example Methods for Jointly Updating Cell and Timing Advance (TA) and/or Timing Advance Group Identification (TAG-ID) Per Cell

Aspects of the present disclosure provide apparatus, methods, processing systems, and computer readable mediums for jointly updating, through physical layer (PHY) or medium access control (MAC) layer signaling, cell and timing advance (TA) and/or timing advance group identification (TAG-ID) per cell.

The techniques presented herein may be applied in various bands utilized for NR. For example, for the higher band referred to as FR4 (e.g., 52.6 GHz-114.25 GHz), an OFDM waveform with very large subcarrier spacing (960 kHz-3.84 MHz) is required to combat severe phase noise. Due to the large subcarrier spacing, the slot length tends to be very short. In a lower band referred to as FR2 (24.25 GHz to 52.6 GHz) with 120 kHz SCS, the slot length is 125 μSec, while in FR4 with 960 kHz, the slot length is 15.6 μSec.

In multi-beam operation (e.g., involving FR1 and FR2 bands), more efficient uplink/downlink beam management may allow for increased intra-cell and inter-cell mobility (e.g., L1 and/or L2-centric mobility) and/or a larger number of transmission configuration indicator (TCI) states. For example, the states may include the use of a common beam for data and control transmission and reception for UL and DL operations, a unified TCI framework for UL and DL beam indication, and enhanced signaling mechanisms to improve latency and efficiency (e.g., dynamic usage of control signaling).

Some features may facilitate UL beam selection for UEs equipped with multiple panels. For example, UL beam selection may be facilitated through UL beam indication based on a unified TCI framework, enabling simultaneous transmission across multiple panels, and enabling fast panel selection. Further, UE-initiated or L1-event-driven beam management may also reduce latency and the probability that beam failure events occur.

Additional techniques for multi-TRP deployment may target both FR1 and FR2 bands. These techniques may improve reliability and robustness for channels other than the PDSCH (e.g., PDCCH, PUSCH, and PUCCH) using multi-TRP and/or multi-panel operations. These techniques may, in some cases, be related to quasi co-location (QCI) and TCI that may enable inter-cell multi-TRP operations and may allow for simultaneous multi-TRP transmission with multi-panel reception, assuming multi-DCI-based multi-PDSCH reception.

Still further techniques may support single frequency networks (SFNs) in high speed environments (e.g., in the High Speed Train (HST) scenario). These techniques may include QCL assumptions for demodulation reference signals (DMRS), such as multiple QCL assumptions for the same DMRS ports and/or targeting downlink-only transmission. In some cases, the techniques may specify a QCL or QCL-like relation, including applicable QCL types and associated requirements, between downlink and uplink signals by using a unified TCI framework.

In Rel-15 and Rel-16, each serving cell may have an RRC-configured serving cell ID and an RRC-configured physical cell indicator (PCI). A UE may also acquire the physical cell identifier from the synchronization signal block (SSB) of the serving cell.

To enable L1 (e.g., physical layer)/L2 (e.g., medium access control (MAC) layer) based inter-cell mobility, a gNB may need to know whether a UE supports L1/L2 mobility. L1/L2 based inter-cell mobility may include various operating modes, the properties of each of which may be defined a priori and support of which may be signaled to a gNB individually or as a blanket indication of support for L1/L2 mobility. In a first operating mode, each serving cell can have a PCI and multiple physical cell sites (e.g., remote radio headers (RRHs)). Each RRH may transmit a different set of SSB IDs using the same PCI. A DCI or MAC-CE may select which RRH or corresponding SSB to serve the UE based on signal strength metrics (e.g., reference signal received power (RSRP) per reported SSB ID.

In another operating mode, each serving cell may be configured with multiple PCIs. Each RRH of the serving cell can use one of the multiple PCIs configured for the serving cell and can transmit the full set of SSB IDs configured for the cell. A DCI or MAC-CE can select which RRH(s) or corresponding PCI(s) and/or SSB(s) to serve the UE based on signal strength metrics (e.g., RSRP) per reported SSB ID per reported PCI.

In still another operating mode, each serving cell may be configured with a single PCI. A DCI or MAC-CE can identify serving cell(s) or corresponding serving cell ID(s) to serve the UE based on signal strength metrics (e.g., RSRP) pre reported SSB ID per reported PCI.

While the above refers to selection or use of SSBs, it should be understood that other cell-identifying reference signals may be used to identify a serving cell to serve a UE. For example, channel state information (CSI) reference signals (CSI-RS) or positioning reference signals (PRSs) can be used to identify the serving cell(s) to serve the UE.

In L1/L2-based inter-cell mobility, separate DCIs or MAC-CEs may be used to signal, to a UE, the newly selected cell and the PDCCH order for timing advance (TA) updates. However, separate DCIs or MAC-CEs may introduce latency in L1/L2-based mobility, as a UE may need to wait for the PDCCH order for TA updates to be conveyed before handing over and communicating with the newly selected cell.

FIG. 4 illustrates example operations 400 that may be performed by a UE to update, through physical layer (PHY) or medium access control (MAC) layer signaling, cell and timing advance (TA) per cell, in accordance with certain aspects of the present disclosure. Operations 400 may be performed, for example, by a UE 120 illustrated in FIG. 1.

Operations 400 begin, at 402, where the UE receives, via physical (PHY) layer or medium access control (MAC) layer signaling, a joint update to at least one serving cell to serve the UE and a timing advance (TA). As discussed in further detail herein, the joint update to the at least one serving cell and the TA may include a cell identifier associated with the at least one serving cell and timing information for one or more timing advance groups (TAG) to which the at least one serving cell belongs. The timing information may indicate, for each respective TAG, timing information that the UE can use to perform a random access channel (RACH) procedure with cells associated with the respective TAG, which may allow the UE to perform mobility procedures with respect to the at least one serving cell without needing to wait for timing information to be conveyed in another message.

At 404, the UE applies the updated TA while communicating in the at least one serving cell. In applying the updated TA, the UE can adjust its timing and transmit signaling to the at least one serving cell such that the at least one serving cell receives the signaling at a time at which such signaling is expected to be received. Further, the UE can adjust its timing such that signaling is received from the at least one serving cell at a time at which such signaling is expected to be received. That is, the UE can apply the updated TA so that uplink and downlink signaling is transmitted and received according to an uplink/downlink slot or subframe configuration. Uplink signaling, thus, may not be transmitted at a time in which downlink signaling is expected to be received from the at least one serving cell, and downlink signaling may not be received at a time in which the UE is expected to transmit uplink signaling to the at least one serving cell.

FIG. 5 illustrates example operations 500 that may be performed by a network entity to update, through physical layer (PHY) or medium access control (MAC) layer signaling, cell and timing advance (TA) per cell, in accordance with certain aspects of the present disclosure. The operations 500 of FIG. 5 may be complementary to the operations 400 of FIG. 4. For example, operations 500 may be performed by a BS 110a-z (such as a NodeB and/or in a pico cell, a femto cell, or the like) illustrated in FIG. 1 to communicate with a UE 120 performing operations 400.

Operations 500 begin, at 502, where the network entity determines at least one timing advance (TA) for a user equipment (UE) in at least one serving cell. The at least one TA for a UE in at least one serving cell may be, for example, a TA associated with a TAG in which the at least one serving cell is a member. The TA may be applicable to any cell in the TAG, including the at least one serving cell.

At 504, the network entity sends the UE, via physical (PHY) layer or medium access control (MAC) layer signaling, a joint update to the at least one serving cell to serve the UE and the TA. As discussed, the joint update may allow for a UE to communicate with the at least one serving cell without needing to receive a first message including an update to the at least one serving cell and a second message including an update to the TA for the at least one serving cell, which may reduce latencies in communicating with cells in a wireless network and may reduce latencies in handing over from a source cell to a target cell, performing RACH procedures to communicate with a target cell, and the like.

The PHY layer or MAC layer signaling can include at least one of a downlink control information (DCI) or medium access control (MAC) control element (CE).

The PHY layer or MAC layer signaling can identify the at least one serving cell via at least one of a physical cell ID (PCI) or a serving cell ID. Each PCI configured for each serving cell can be assigned a timing advance group (TAG) ID. The updated TA can be applied to all PCIs with the same TAG ID.

The PHY layer or MAC layer signaling can carry one or more TA values for TAGs of one or more selected cells and carry PDCCH order information scheduling the UE to perform a random access channel (RACH) procedure on one or more selected cells and updating a TA value. If multiple cells are selected, the PHY layer or MAC layer signaling can indicate one or more of the multiple cells with which the UE is to perform a RACH procedure. In some aspects, the order of the one or more of the multiple cells with which the UE is to perform a RACH procedure may indicate, for example, an order in which the UE is to perform the RACH procedure or a prioritization of the one or more of the multiple cells.

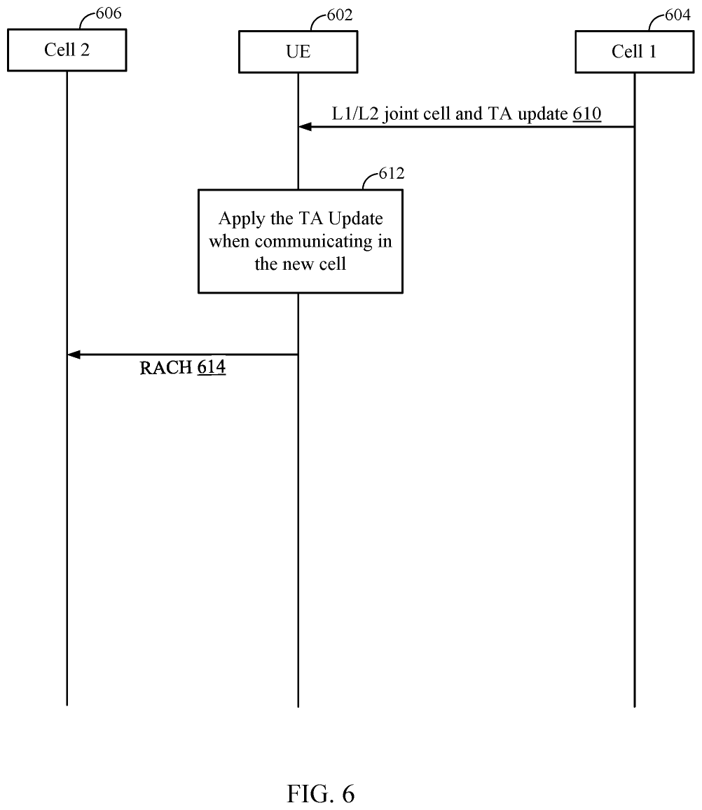

FIG. 6 is a call flow diagram illustrating the joint update, through PHY/MAC layer signaling, cell and TA per cell. As illustrated, the UE 602 receives a PHY/MAC joint cell selection and TA command 610 from a first cell (i.e., cell 604 illustrated in FIG. 6). The PHY/MAC cell selection command and TA command 610 generally identifies a new cell (i.e., cell 606 illustrated in FIG. 6) with which the UE is to communicate. Thus, the PHY/MAC cell selection command and TA command 610 may indicate that the UE is to hand over or otherwise perform mobility procedures with respect to cell 606.

Based on receiving the PHY/MAC cell selection command, the UE 602 applies, at block 612, the TA update when communicating with the new cell. At some later point in time, the UE 602 performs a RACH operation 614 with the new cell (e.g., cell 606) based on the applied timing advance update. In performing the RACH operation 614, the UE 602 can transmit a random access request to cell 606 based on the TA update applied at block 612 such that the random access request is received at a time at which the cell 606 expects to receive random access requests. In response, the UE 602 receives a random access response including, for example, information that the UE 602 can use to detect a physical downlink control channel transmitted by the cell 606, along with scheduling information and other information that the UE 602 can use to handover to cell 606. Subsequently, the UE 602 hands over to cell 606 and discontinues communications with cell 604.

In some embodiments, L1/L2 signaling may be used to update a timing advance group (TAG) ID for one or more serving cells or cells associated with one or more PCIs. The L1/L2 signaling may be used to signal, for example, adjustments or changes in the TAG membership for each serving cell or for each cell associated with a given PCI. Because each TAG may be associated with a TA value for the TAG, updating the TAG ID associated with a cell may effectively update the TA value associated with the cell.

FIG. 7 illustrates example operations 700 that may be performed by a UE to update, through PHY or MAC layer signaling, TAG-IDs per cell, in accordance with certain aspects of the present disclosure. Operations 700 may be performed, for example, by a UE 120 illustrated in FIG. 1.

Operations 700 begin, at 702, where the UE receives, via physical (PHY) layer or medium access control (MAC) layer signaling, an update to a timing advance (TA) group (TAG) ID for one or more serving cells of the UE.

At 704, the UE applies the update while communicating in the one or more serving cells.

FIG. 8 illustrates example operations 800 that may be performed by a network entity to update, through physical layer (PHY) or medium access control (MAC) layer signaling, cell and timing advance (TA) per cell, in accordance with certain aspects of the present disclosure. Operations 800 of FIG. 8 may be complementary to the operations 700 of FIG. 7. For example, operations 800 may be performed, by a BS 110a-z (such as a NodeB and/or in a pico cell, a femto cell, or the like) illustrated in FIG. 1 to communicate with a UE 120 performing operations 700 of FIG. 7.

As illustrated, operations 800 begin, at 802, where the network entity determines an update to a timing advance (TA) group (TAG) ID for one or more serving cells of a user equipment (UE).

At 804, the network entity sends the update to the UE, via PHY layer or medium access control (MAC) layer signaling.

The physical layer or MAC layer signaling can include at least one of a downlink control information (DCI) or medium access control (MAC) control element (CE).

The PHY layer or MAC layer signaling can identify the one or more serving cells via at least one of a physical cell ID (PCI) or a serving cell ID. Each PCI configured for each serving cell can be assigned a timing advance group (TAG) ID, and a common TA can be applied to all PCIs with the same TAG ID. The PHY layer or MAC layer signaling can indicate multiple TAG-IDs with multiple serving cells or PCIs per TAG-ID.

A serving cell can be configured with one or multiple PCIs, and the UE can also receive updates to one or more PCIs that serve the UE via physical layer or medium access control (MAC) layer signaling. The same serving cell can have multiple TAG-IDs, with each associated with a different set of one or more of the multiple PCIs.

In L1/L2 operation mode 1, which involves an L1/L2-based PCI switch, each serving cell can be configured with one or multiple PCIs. Each RRH of the serving cell can use one PCI configured for the serving cell and can transmit a full set of SSB IDs. The network entity can send updates to one or more PCIs that serve the UE via physical layer or medium access control (MAC) layer signaling. The same serving cell can have multiple TAG IDs, with each associated with a different set of one or more of the multiple PCIs. A DCI or MAC-CE can select which RRHs or corresponding PCI(s) and/or SSB(s) to serve the UE based on signal quality metrics (e.g., RSRP) per reported SSB ID per reported PCI.

Based on receiving the TAG ID update, the UE can apply a common TA value to all cells with same TAG ID. As discussed, by updating the TAG ID associated with a cell, and applying the common TA value to all cells with the same TAG ID, the timing advance value for the cell may be updated from the TA value associated with the cell's previous TAG ID to the common TA value associated with the updated TAG ID.

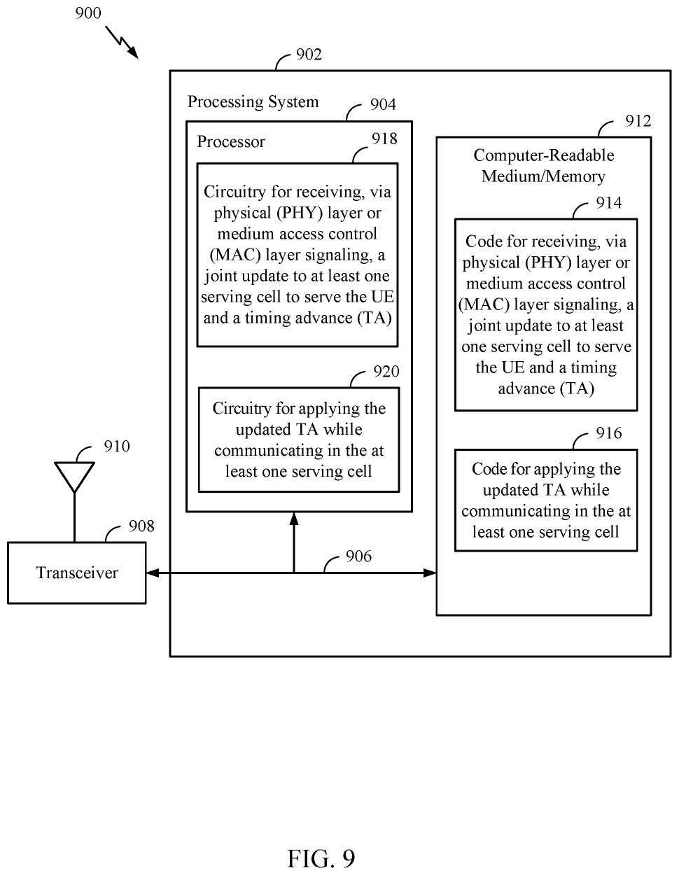

FIG. 9 illustrates a communications device 900 that may include various components (e.g., corresponding to means-plus-function components) configured to perform operations for the techniques disclosed herein, such as the operations illustrated in FIG. 4. The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIG. 4, or other operations for performing the various techniques discussed herein for updating timing advance information in L1/L2 mobility. In certain aspects, computer-readable medium/memory 912 stores code 914 for receiving, via physical (PHY) layer or medium access control (MAC) layer signaling, a joint update to at least one serving cell to serve the UE and a timing advance (TA); and code 916 for applying the updated TA while communicating in the at least one serving cell, in accordance with aspects of the present disclosure. In certain aspects, the processor 904 has circuitry configured to implement the code stored in the computer-readable medium/memory 912. The processor 904 includes circuitry 918 for receiving, via physical (PHY) layer or medium access control (MAC) layer signaling, a joint update to at least one serving cell to serve the UE and a timing advance (TA); and circuitry 920 for applying the updated TA while communicating in the at least one serving cell, in accordance with aspects of the present disclosure.

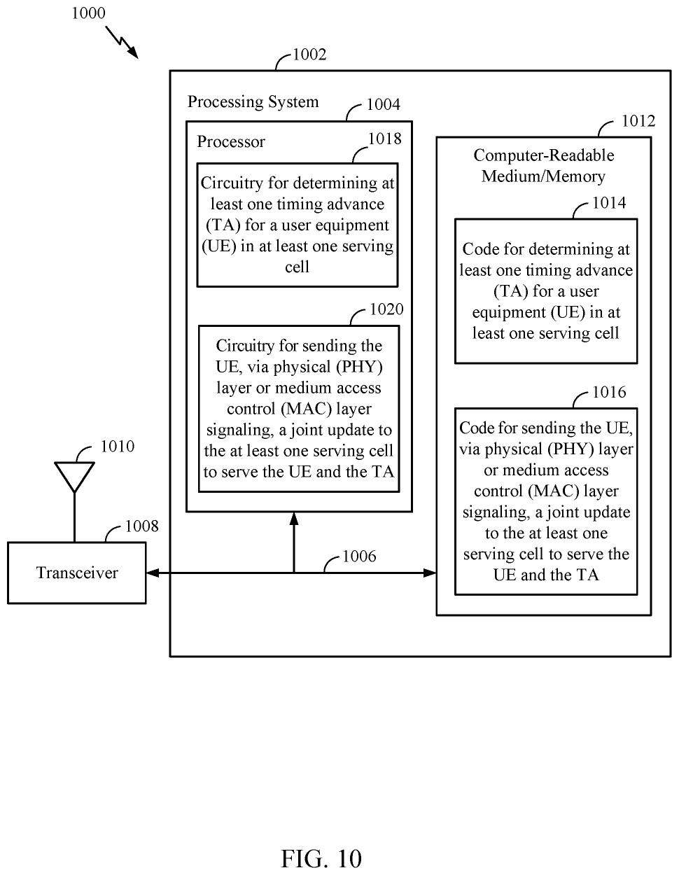

FIG. 10 illustrates a communications device 1000 that may include various components (e.g., corresponding to means-plus-function components) configured to perform operations for the techniques disclosed herein, such as the operations illustrated in FIG. 5. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 5, or other operations for performing the various techniques discussed herein for updating timing advance information in L1/L2 mobility. In certain aspects, computer-readable medium/memory 1012 stores code 1014 for determining at least one timing advance (TA) for a user equipment (UE) in at least one serving cell; and code 1016 for sending the UE, via physical (PHY) layer or medium access control (MAC) layer signaling, a joint update to the at least one serving cell to serve the UE and the TA, in accordance with aspects of the present disclosure. In certain aspects, the processor 1004 has circuitry configured to implement the code stored in the computer-readable medium/memory 1012. The processor 1004 includes circuitry 1018 for determining at least one timing advance (TA) for a user equipment (UE) in at least one serving cell; and circuitry 1020 for sending the UE, via physical (PHY) layer or medium access control (MAC) layer signaling, a joint update to the at least one serving cell to serve the UE and the TA, in accordance with aspects of the present disclosure.

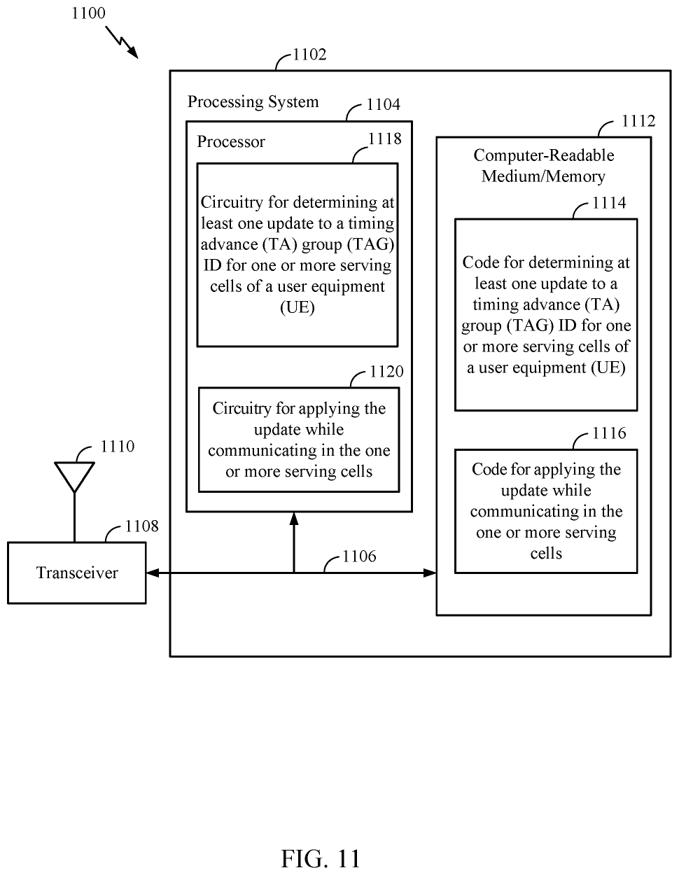

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7, or other operations for performing the various techniques discussed herein for updating timing advance information in L1/L2 mobility. In certain aspects, computer-readable medium/memory 1112 stores code 1114 for determining at least one update to a timing advance (TA) group (TAG) ID for one or more serving cells of a user equipment (UE); and code 1116 for applying the update while communicating in the one or more serving cells, in accordance with aspects of the present disclosure. In certain aspects, the processor 1104 has circuitry configured to implement the code stored in the computer-readable medium/memory 1112. The processor 1104 includes circuitry 1118 for determining at least one update to a timing advance (TA) group (TAG) ID for one or more serving cells of a user equipment (UE); and circuitry 1120 for applying the update while communicating in the one or more serving cells, in accordance with aspects of the present disclosure.

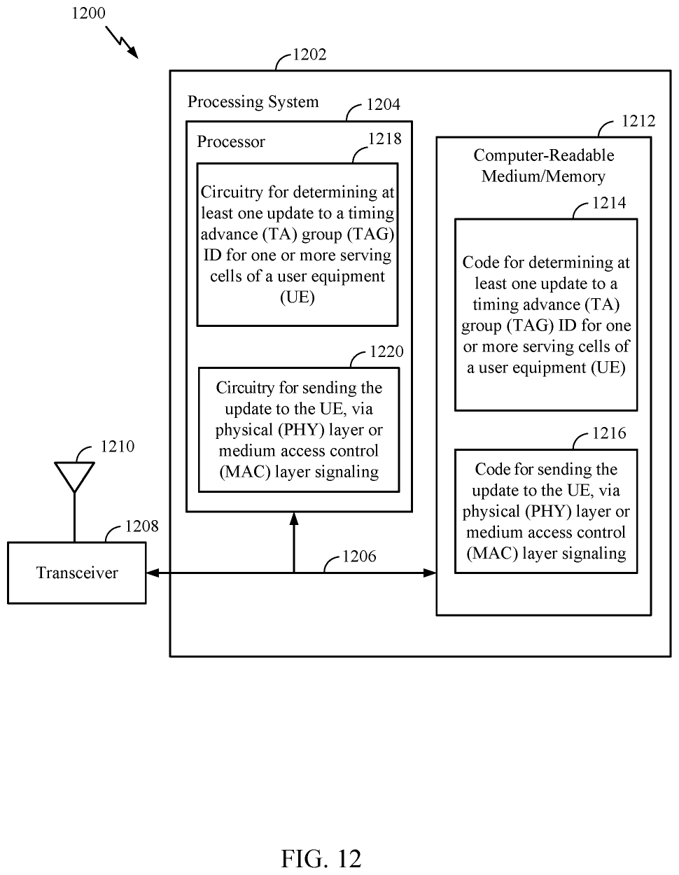

FIG. 12 illustrates a communications device 1200 that may include various components (e.g., corresponding to means-plus-function components) configured to perform operations for the techniques disclosed herein, such as the operations illustrated in FIG. 8. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 8, or other operations for performing the various techniques discussed herein for updating timing advance information in L1/L2 mobility. In certain aspects, computer-readable medium/memory 1212 stores code 1214 for determining at least one update to a timing advance (TA) group (TAG) ID for one or more serving cells of a user equipment (UE); and code 1216 for sending the update to the UE, via physical (PHY) layer or medium access control (MAC) layer signaling, in accordance with aspects of the present disclosure. In certain aspects, the processor 1204 has circuitry configured to implement the code stored in the computer-readable medium/memory 1212. The processor 1204 includes circuitry 1218 for determining at least one update to a timing advance (TA) group (TAG) ID for one or more serving cells of a user equipment (UE); and circuitry 1220 for sending the update to the UE, via physical (PHY) layer or medium access control (MAC) layer signaling, in accordance with aspects of the present disclosure.

### Example Embodiments

Embodiment 1: A method for wireless communications by a user equipment (UE), comprising: receiving, via physical (PHY) layer or medium access control (MAC) layer signaling, a joint update to at least one serving cell to serve the UE and a timing advance (TA); and applying the updated TA while communicating in the at least one serving cell.

Embodiment 2: The method of Embodiment 1, wherein the signaling comprises downlink control information (DCI).

Embodiment 3: The method of Embodiment 1, wherein the signaling comprises a medium access control (MAC) control element (CE).

Embodiment 4: The method of any of Embodiments 1 through 3, wherein the signaling identifies the at least one serving cell via at least one of a physical cell ID (PCI) or a serving cell ID.

Embodiment 5: The method of Embodiment 4, wherein: each PCI configured for each serving cell is assigned a timing advance group (TAG) ID; and the updated TA is applied to all PCIs with the same TAG ID.

Embodiment 6: The method of any of Embodiments 1 through 5, wherein the signaling carries PDCCH order information for scheduling the UE to perform a random access channel (RACH) procedure on one or more selected cells and update the TA.

Embodiment 7: The method of Embodiment 6, wherein, if multiple cells are selected, the signaling indicates one or more of the multiple cells for the UE to perform a RACH procedure.

Embodiment 8: The method of any of Embodiments 1 through 7, wherein the signaling comprises one or more TA values for one or more TAG groups of the at least one serving cell.

Embodiment 9: A method for wireless communications by a user equipment (UE), comprising: receiving, via physical (PHY) layer or medium access control (MAC) layer signaling, an update to a timing advance (TA) group (TAG) ID for one or more serving cells of the UE; and applying the update while communicating in the one or more serving cells.

Embodiment 10: The method of Embodiment 9, wherein the signaling comprises downlink control information (DCI) signaling.

Embodiment 11: The method of Embodiment 9, wherein the signaling comprises a medium access control (MAC) control element (CE).

Embodiment 12: The method of any of Embodiments 9 through 11, wherein the signaling identifies the one or more serving cells via at least one of a physical cell ID (PCI) or a serving cell ID.

Embodiment 13: The method of Embodiment 12, wherein: each PCI configured for each serving cell is assigned a timing advance group (TAG) ID; and a common TA is applied to all PCIs with the same TAG ID.

Embodiment 14: The method of Embodiment 12, wherein the signaling indicates multiple TAG-IDs with multiple serving cells or PCIs per TAG-ID.

Embodiment 15: The method of Embodiment 12, wherein: a serving cell is configured with one or multiple PCIs; and the UE also receives updates to one or more PCIs that serve the UE via physical layer or medium access control (MAC) layer signaling.

Embodiment 16: The method of Embodiment 15, wherein the same serving cell is associated with multiple TAG-IDs, each associated with a different set of one or more of the multiple PCIs.

Embodiment 17: A method for wireless communications by a network entity, comprising: determining at least one timing advance (TA) for a user equipment (UE) in at least one serving cell; and sending the UE, via physical (PHY) layer or medium access control (MAC) layer signaling, a joint update to the at least one serving cell to serve the UE and the TA.

Embodiment 18: The method of Embodiment 17, wherein the signaling comprises at least one of a downlink control information (DCI) or medium access control (MAC) control element (CE).

Embodiment 19: The method of Embodiments 17 or 18, wherein the signaling identifies the at least one serving cell via at least one of a physical cell ID (PCI) or a serving cell ID.

Embodiment 20: The method of Embodiment 19, wherein: each PCI configured for each serving cell is assigned a timing advance group (TAG) ID; and the updated TA is applied to all PCIs with the same TAG ID.

Embodiment 21: The method of any of Embodiments 17 through 20, wherein the signaling also carries PDCCH order information for scheduling the UE to perform a random access channel (RACH) procedure on one or more selected cells and update the TA.

Embodiment 22: The method of Embodiment 21, wherein, if multiple cells are selected, the signaling indicates one or more of the multiple cells for the UE to perform a RACH procedure.

Embodiment 23: The method of any of Embodiments 17 through 22, wherein the signaling comprises one or more TA values for one or more TAG groups of the at least one serving cell.

Embodiment 24: A method for wireless communications by a network entity, comprising: determining an update to a timing advance (TA) group (TAG) ID for one or more serving cells of a user equipment (UE); and sending the update to the UE, via physical (PHY) layer or medium access control (MAC) layer signaling.

Embodiment 25: The method of Embodiment 24, wherein the signaling comprises at least one of a downlink control information (DCI) or medium access control (MAC) control element (CE).

Embodiment 26: The method of Embodiments 24 or 25, wherein the signaling identifies the one or more serving cells via at least one of a physical cell ID (PCI) or a serving cell ID.

Embodiment 27: The method of Embodiment 26, wherein: each PCI configured for each serving cell is assigned a timing advance group (TAG) ID; and a common TA is applied to all PCIs with the same TAG ID.

Embodiment 28: The method of Embodiment 26, wherein the signaling indicates multiple TAG-IDs with multiple serving cells or PCIs per TAG-ID.

Embodiment 29: The method of Embodiment 26, wherein: a serving cell is configured with one or multiple PCIs; and the network entity also sends updates to one or more PCIs that serve the UE via physical layer or medium access control (MAC) layer signaling.

Embodiment 30: The method of Embodiment 29, wherein the same serving cell can have multiple TAG-IDs, each associated with a different set of one or more of the multiple PCIs.

Embodiment 31: An apparatus for wireless communications by a user equipment (UE), comprising: a processor; and a memory having instructions which, when executed by the processor, performs the operations of any of Embodiments 1 through 8.

Embodiment 32: An apparatus for wireless communications by a user equipment (UE), comprising: a processor; and a memory having instructions which, when executed by the processor, performs the operations of any of Embodiments 9 through 16.

Embodiment 33: An apparatus for wireless communications by a network entity, comprising: a processor; and a memory having instructions which, when executed by the processor, performs the operations of any of Embodiments 17 through 23.

Embodiment 34: An apparatus for wireless communications by a network entity, comprising: a processor; and a memory having instructions which, when executed by the processor, performs the operations of any of Embodiments 24 through 30.

Embodiment 35: An apparatus for wireless communications by a user equipment (UE), comprising: means capable of performing the operations of any of Embodiments 1 through 8.

Embodiment 36: An apparatus for wireless communications by a user equipment (UE), comprising: means capable of performing the operations of any of Embodiments 9 through 16.

Embodiment 37: An apparatus for wireless communications by a network entity, comprising: means capable of performing the operations of any of Embodiments 17 through 23.

Embodiment 38: An apparatus for wireless communications by a network entity, comprising: means capable of performing the operations of any of Embodiments 24 through 30.

Embodiment 39: A computer-readable medium having instructions stored thereon which, when executed by a processor, performs the operations of any of Embodiments 1 through 8.

Embodiment 40: A computer-readable medium having instructions stored thereon which, when executed by a processor, performs the operations of any of Embodiments 9 through 16.

Embodiment 41: A computer-readable medium having instructions stored thereon which, when executed by a processor, performs the operations of any of Embodiments 17 through 23.

Embodiment 42: A computer-readable medium having instructions stored thereon which, when executed by a processor, performs the operations of any of Embodiments 24 through 30.

### Additional Considerations

The techniques described herein may be used for various wireless communication technologies, such as NR (for example, 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, or 5G wireless technologies, aspects of the present disclosure can be applied in other generation-based communication systems.

In 3GPP, the term “cell” can refer to a coverage area of a Node B (NB) or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, or other types of cells. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having an association with the femto cell (for example, UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (for example, a smart ring, a smart bracelet, etc.), an entertainment device (for example, a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, which may be narrowband IoT (NB-IoT) devices.

Some wireless networks (for example, LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (for example, 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (for example, 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (for example, a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (for example, one or more other UEs), and the other UEs may utilize the resources scheduled by the UE for wireless communication. In some examples, a UE may function as a scheduling entity in a peer-to-peer (P2P) network, or in a mesh network. In a mesh network example, UEs may communicate directly with one another in addition to communicating with a scheduling entity.

As used herein, the term “determining” may encompass one or more of a wide variety of actions. For example, “determining” may include calculating, computing, processing, deriving, investigating, looking up (for example, looking up in a table, a database or another data structure), assuming and the like. Also, “determining” may include receiving (for example, receiving information), accessing (for example, accessing data in a memory) and the like. Also, “determining” may include resolving, selecting, choosing, establishing and the like.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communications by a user equipment (UE), comprising:
receiving, via physical (PHY) layer or medium access control (MAC) layer signaling, a joint update to at least one serving cell to serve the UE and a timing advance (TA); and
applying the updated TA while communicating in the at least one serving cell.

2. The method of claim 1, wherein the signaling comprises downlink control information (DCI).

3. The method of claim 1, wherein the signaling comprises a medium access control (MAC) control element (CE).

4. The method of claim 1, wherein the signaling identifies the at least one serving cell via at least one of a physical cell ID (PCI) or a serving cell ID.

5. The method of claim 4, wherein:
each PCI configured for each serving cell is assigned a timing advance group (TAG) ID; and
the updated TA is applied to all PCIs with the same TAG ID.

6. The method of claim 1, wherein the signaling carries PDCCH order information for scheduling the UE to perform a random access channel (RACH) procedure on one or more selected cells and update the TA.

7. The method of claim 6, wherein, if multiple cells are selected, the signaling indicates one or more of the multiple cells for the UE to perform a RACH procedure.

8. The method of claim 1, wherein the signaling comprises one or more TA values for one or more TAG groups of the at least one serving cell.

9. A method for wireless communications by a user equipment (UE), comprising:
receiving, via physical (PHY) layer or medium access control (MAC) layer signaling, an update to a timing advance (TA) group (TAG) ID for one or more serving cells of the UE; and
applying the update while communicating in the one or more serving cells.

10. The method of claim 9, wherein the signaling comprises downlink control information (DCI) signaling.

11. The method of claim 9, wherein the signaling comprises a medium access control (MAC) control element (CE).

12. The method of claim 9, wherein the signaling identifies the one or more serving cells via at least one of a physical cell ID (PCI) or a serving cell ID.

13. The method of claim 12, wherein:
each PCI configured for each serving cell is assigned a timing advance group (TAG) ID; and
a common TA is applied to all PCIs with the same TAG ID.

14. The method of claim 12, wherein the signaling indicates multiple TAG-IDs with multiple serving cells or PCIs per TAG-ID.

15. The method of claim 12, wherein:
a serving cell is configured with one or multiple PCIs; and
the UE also receives updates to one or more PCIs that serve the UE via physical layer or medium access control (MAC) layer signaling.

16. The method of claim 15, wherein the same serving cell is associated with multiple TAG-IDs, each associated with a different set of one or more of the multiple PCIs.

17. A method for wireless communications by a network entity, comprising:
determining at least one timing advance (TA) for a user equipment (UE) in at least one serving cell; and
sending the UE, via physical (PHY) layer or medium access control (MAC) layer signaling, a joint update to the at least one serving cell to serve the UE and the TA.

18. The method of claim 17, wherein the signaling comprises at least one of a downlink control information (DCI) or medium access control (MAC) control element (CE).

19. The method of claim 17, wherein the signaling identifies the at least one serving cell via at least one of a physical cell ID (PCI) or a serving cell ID.

20. The method of claim 19, wherein:
each PCI configured for each serving cell is assigned a timing advance group (TAG) ID; and
the updated TA is applied to all PCIs with the same TAG ID.

21. The method of claim 17, wherein the signaling also carries PDCCH order information for scheduling the UE to perform a random access channel (RACH) procedure on one or more selected cells and update the TA.

22. The method of claim 21, wherein, if multiple cells are selected, the signaling indicates one or more of the multiple cells for the UE to perform a RACH procedure.

23. The method of claim 17, wherein the signaling comprises one or more TA values for one or more TAG groups of the at least one serving cell.

24. A method for wireless communications by a network entity, comprising:
determining an update to a timing advance (TA) group (TAG) ID for one or more serving cells of a user equipment (UE); and
sending the update to the UE, via physical (PHY) layer or medium access control (MAC) layer signaling.

25. The method of claim 24, wherein the signaling comprises at least one of a downlink control information (DCI) or medium access control (MAC) control element (CE).

26. The method of claim 24, wherein the signaling identifies the one or more serving cells via at least one of a physical cell ID (PCI) or a serving cell ID.

27. The method of claim 26, wherein:
each PCI configured for each serving cell is assigned a timing advance group (TAG) ID; and
a common TA is applied to all PCIs with the same TAG ID.

28. The method of claim 26, wherein the signaling indicates multiple TAG-IDs with multiple serving cells or PCIs per TAG-ID.

29. The method of claim 26, wherein:
a serving cell is configured with one or multiple PCIs; and
the network entity also sends updates to one or more PCIs that serve the UE via physical layer or medium access control (MAC) layer signaling.

30. The method of claim 29, wherein the same serving cell can have multiple TAG-IDs, each associated with a different set of one or more of the multiple PCIs.
